(19) United States
(12) Patent Application Publication
(10) Pub. No.: US 2026/0323138 A1
(43) Pub. Date: Oct. 15, 2026

(54) INFRARED THERMAL IMAGING SYSTEM WITH IN-PIXEL NEUROMORPHIC COMPUTING

(71) Applicant: Purdue Research Foundation, West Lafayette, IN (US)

(72) Inventors: Leif Harrison Bauer, Lafayette, IN (US); Zubin Jacob, West Lafayette, IN (US); Mohamed A. Mousa, Lafayette, IN (US); Utkarsh Singh, West Lafayette, IN (US)

(21) Appl. No.: 19/467,249

(22) Filed: Feb. 2, 2026

Related U.S. Application Data
(60) Provisional application No. 63/754,942, filed on Feb. 6, 2025.

(51) Int. Cl. H04N 23/23; G01J 5/00; G01J 5/20; G06V 10/147; G06V 10/764; G06V 10/82; H04N 25/78

(52) U.S. Cl. CPC H04N 23/23; G01J 5/20; G06V 10/82; H04N 25/78; G01J 2005/0077; G01J 2005/202; G06V 10/147; G06V 10/764

(57) ABSTRACT

A thermal imaging system comprises an array of spintronic ultrafast nanoscale bolometers configured to generate a thermal image. The thermal imaging system further comprises at least one further array of spintronic ultrafast nanoscale bolometers configured to generate at least one set of synaptic weights. The thermal imaging system further comprises at least one digital circuit configured to implement an artificial neural network that performs an image processing task. The artificial neural network has an input layer that receives the thermal image from the first array of bolometers. The artificial neural network has at least one additional layer that generates an output of the image processing task by performing at least one operation on the thermal image using the at least one set of synaptic weights.

This application claims the benefit of priority of U.S. provisional application Ser. No. 63/754,942, filed on Feb. 6, 2025 the disclosure of which is herein incorporated by reference in its entirety.

### FIELD

The devices and methods disclosed in this document relate to thermal imaging and, more particularly, to infrared thermal imaging with in-pixel neuromorphic computing.

### BACKGROUND

Unless otherwise indicated herein, the materials described in this section are not admitted to be the prior art by inclusion in this section.

Thermal imaging in the long-wave infrared (LWIR) spectrum is crucial for applications such as surveillance, autonomous navigation, and biomedical diagnostics. It provides visibility in darkness and through adverse weather, enables heat signature detection, and supports high-resolution thermal imaging at micro- and nanoscale levels. Advances in hardware-accelerated photonic front-end sensing highlight the potential of optical preprocessing for real-time perception. Combined with algorithmic developments and machine learning, artificial-intelligence (AI) enhanced thermal imaging can enable highly efficient object detection, recognition, and depth perception. Notable advances, such as heat-assisted detection and ranging, combine thermal imaging with machine learning to enable depth perception in complete darkness. However, AI-enhanced thermal imaging currently faces slow processing speeds and high-power consumption. Thus, a new generation of thermal detectors is needed for a wide range of infrared applications, including anomaly detection, autonomous navigation, and biomedical diagnostics, where high-speed and low-power operation are essential.

At the core of current thermal imaging systems are bolometers, devices whose electrical resistance changes with temperature, enabling the detection and measurement of thermal radiation. Traditional vanadium dioxide (VO₂) microbolometers, while sensitive and among the state-of-the-art options for room-temperature operation, have been relatively slow. Recent advances have led to the development of room-temperature detectors that demonstrate significant improvements in either sensitivity or response time. Innovations involving graphene and nanoscale structures have enabled impressive readout speeds ranging from 1 to 200 GHz. Other advances in infrared detectors, such as energy-efficient black-phosphorus-based sensors, show promise, but challenges like scalability and long-term stability remain. Recent probabilistic plasmonic-spintronic bolometers have also advanced scalable digital LWIR sensing by integrating nanoscale stochastic detectors into multipixel arrays. One recent work developed the MoS₂/black-phosphorus heterojunction with integrated photodetection, memory, and computing, achieving high precision and low energy consumption but limited by narrow bandwidth (1.5-3.9 μm) and slow response time. However, achieving a simultaneous balance of high-sensitivity and high-speed operation remains a persistent challenge, particularly in demanding applications such as thermal lidar, night vision, and free-space communication.

### SUMMARY

A thermal imaging system is described herein. The thermal imaging system comprises a first array of bolometers configured to generate a thermal image. The thermal imaging system further comprises at least one further array of bolometers configured to generate at least one set of weights. The thermal imaging system further comprises at least one digital circuit configured to implement an artificial neural network that performs an image processing task. The artificial neural network has (i) an input layer that receives the thermal image from the first array of bolometers and (ii) at least one additional layer that generates an output of the image processing task by performing at least one operation on the thermal image using the at least one set of weights.

### BRIEF DESCRIPTION OF THE DRAWINGS

The foregoing aspects and other features of the system are explained in the following description, taken in connection with the accompanying drawings.

FIG. 1 shows a thermal imaging system, which is referred to herein as a neural bolometer.

FIG. 2A shows the operation and structure of an exemplary SUN bolometer.

FIG. 2B shows a successful fabrication of a 32×32 SUN bolometer array.

FIG. 2C shows an exemplary magnetic biasing strategy for a SUN bolometer array.

FIG. 3 shows a detailed schematic of the ANN architecture for the neural bolometer.

FIG. 4A shows a detailed hardware implementation of the neural bolometer.

FIG. 4B shows a detailed hardware implementation of the digitization circuits.

FIG. 4C shows a detailed hardware implementation of the digital circuits.

FIG. 5A shows the experimental output of a single-pixel SUN bolometer compared with the simulated digital output from the digitization circuit.

FIG. 5B shows a corresponding energy diagram of the two magnetic states under field bias.

FIG. 5C shows experimentally measured SUN-bolometer click rates under different bias fields, which were digitized and fitted to a stochastic sigmoid function.

FIG. 5D shows noise equivalent differential temperature (NEDT) versus the applied magnetic field.

FIG. 6 shows a confusion matrix showing the MNIST classification results from the neural bolometer versus the ground truth.

### DETAILED DESCRIPTION

For the purposes of promoting an understanding of the principles of the disclosure, reference will now be made to the embodiments illustrated in the drawings and described in the following written specification. It is understood that no limitation to the scope of the disclosure is thereby intended. It is further understood that the present disclosure includes any alterations and modifications to the illustrated embodiments and includes further applications of the principles of the disclosure as would normally occur to one skilled in the art to which this disclosure pertains.

### Overview

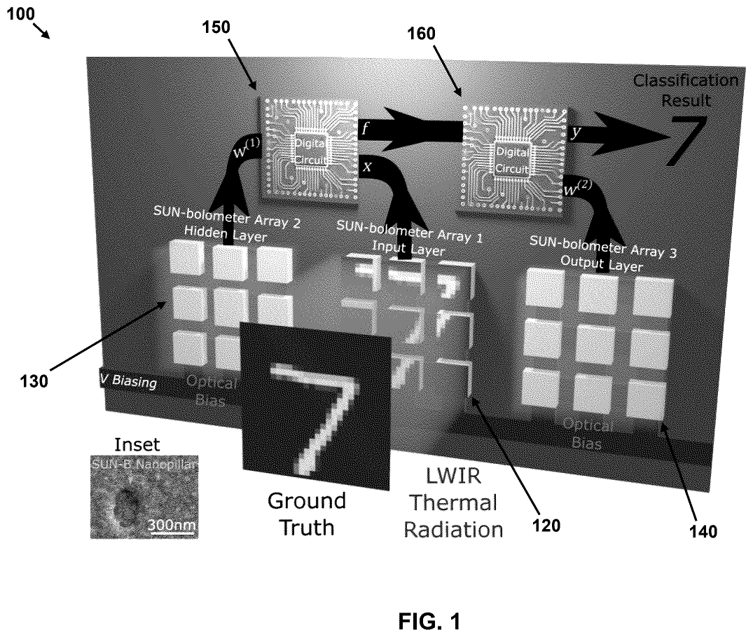

FIG. 1 shows a thermal imaging system, which is referred to herein as a neural bolometer 100. The neural bolometer 100 is an advanced in-sensor computing solution designed for high-speed and energy-efficient processing in Artificial Neural Networks (ANNs). The neural bolometer 100 has a dual role in which it both captures a thermal image and performs neuromorphic computing to process the thermal image. To these ends, the neural bolometer 100 has a plurality of bolometer arrays including, for example, a first bolometer array 120, a second bolometer array 130, and a third bolometer array 140. Additionally, the neural bolometer 100 has one or more digital circuits including, for example, a first digital circuit 150 and a second digital circuit 160.

In at least some embodiments, each of the bolometer arrays 120, 130, 140 comprises an array of Spintronic Ultrafast Nanoscale (SUN)-Bolometers. As discussed in greater detail below, these SUN bolometers are infrared nanophotonic digital bolometers designed with spintronic materials. The SUN bolometers operate at room temperature, addressing the limitations of traditional analog bolometers that require low-temperature environments. The SUN bolometers produce discrete “click” signals similar to those generated by Geiger-mode avalanche diodes, but without requiring active resets, marking a significant advance in infrared detection technology. The discrete readout statistics offer substantial advantages for in-pixel computing, enhancing processing efficiency and scalability.

The neural bolometer 100 includes a first bolometer array 120 that is utilized as the input image sensor and is configured to capture a thermal image X. The first bolometer array 120 is arranged within the neural bolometer 100 such that it is exposed to thermal radiation from the environment that is to be imaged. In the illustrated example, the first bolometer array 120 is exposed to thermal radiation in the long-wave infrared (LWIR) spectrum.

In addition to the first bolometer array 120, the neural bolometer 100 includes one or more additional bolometer arrays. In the illustrated embodiment, the neural bolometer 100 includes the second bolometer array 130 and the third bolometer array 140. However, in other embodiments, the neural bolometer 100 may include different numbers of additional bolometers. Unlike the first bolometer array 120, the additional bolometer arrays are utilized to generate weights for stochastic neuromorphic computing and are arranged within the neural bolometer 100 in a manner that is shielded from the external environment and subjected to controlled biasing conditions. In particular, the second bolometer array 130 is biased so as to generate weights w⁽¹⁾ and the second bolometer array 130 is biased so as to generate weights w⁽²⁾.

The second bolometer array 130 and third bolometer array 140 provide the weights w⁽¹⁾ and w⁽²⁾ in the form of tunable stochastic bit-streams. The first and second sets of weights w⁽¹⁾ and w⁽²⁾ are previously derived in a training process based on a plurality of training data for the image processing task (e.g., classification of MNIST digits). These weights w⁽¹⁾ and w⁽²⁾ are used by the first digital circuit 150 and the second digital circuit 160, respectively, to process the thermal image X to generate a neuromorphic computing output, such as a classification result y. Thus, the first bolometer array 120 forms the bolometer (sensor) part of the neural bolometer 100, whereas the second bolometer array 130 and the third bolometer array 140 form the neuromorphic computing part of the neural bolometer 100.

As will be discussed in greater detail elsewhere herein, this stochastic computing approach enables the first digital circuit 150 and the second digital circuit 160 to have a compact architecture that reduces logic gate requirements, which significantly outperforms existing optical systems.

The first digital circuit 150 and the second digital circuit 160 implement an artificial neural network that performs an image processing task (e.g., classification of MNIST digits). In the examples illustrated herein, the first digital circuit 150 and the second digital circuit 160 implement a neural network. The neural network has an input layer that receives the thermal image X from the first bolometer array 120. Next, the neural network includes a hidden layer that determines an intermediate output fₕ by performing an operation on the thermal image X using the weights w⁽¹⁾ from the second bolometer array 130. Finally, the neural network includes an output layer that determines a final output y of the image processing task by performing an operation on the intermediate output fₕ using the weights w⁽²⁾ from the third bolometer array 140. In at least some embodiments, the first digital circuit 150 implements the operations of the hidden layer and the second digital circuit 160 implements the operations of the output layer.

The neural bolometer 100 represents a significant leap forward by embedding neuromorphic computing directly within the pixel array. This integration streamlines data processing, reducing redundancy and computational burden while substantially improving real-time performance and energy efficiency in thermal imaging applications. By merging sensory, memory, and computational functions, the neural bolometer 100 enhances technologies such as HADAR and broadens its potential across various fields. This approach supports exceptional real-time machine perception, critical for tasks such as edge detection and pattern recognition, and extends its applicability to autonomous navigation, IoT, medical technologies, and robotics.

The neural bolometer 100 advantageously brings in-pixel computing to the field of thermal imaging and addresses several challenges related to power consumption and inference time. Central to the design is the SUN bolometer, which integrates advances in unconventional computing using magnetic tunnel junctions (MTJs). Using discrete readout statistics, the SUN bolometer offers significant advantages for in-pixel computing, enhancing processing efficiency and scalability. MTJs have demonstrated significant promise for efficient in-pixel processing and neural network inference, offering notable advantages in speed, energy efficiency, and scalability. Neural computation encodes numbers in the range [0, 1] as probabilistic bit streams, significantly reducing computational complexity and improving the performance of artificial neural networks (ANNs). The neural bolometer 100 provides neural computation units within a compact architecture, minimizing logic-gate requirements, and directly integrates SUN bolometers to perform both imaging and processing, offering a seamless solution for efficient ANN operations.

The neural bolometer 100 is advantageously compatible with CMOS technology, making it ideal for applications such as anomaly detection and edge computing. Notably, it achieves an over 80% reduction in logic gate requirements, 92.5% testing accuracy with the SC ANN model, MNIST classification expectedly in just 2.6 μs, and expected power consumption of only 1.9 μW. The neural bolometer 100 addresses the challenges of power consumption, area constraints, and the complexity of integrating advanced technologies.

### SUN Bolometer

As mentioned above, the bolometer arrays 120, 130, 140 include spintronic ultrafast nanoscale (SUN) bolometers, which exploit thermally activated spin transitions in magnetic materials to achieve high-speed readout and high sensitivity at room temperature. The SUN bolometer eliminates the need for active reset by exploiting transitions between two bistable magnetization orientations in the sensing layer, which exhibits ferromagnetic order at the local scale but overall superparamagnetic behavior, where thermal fluctuations enable stochastic switching between two stable magnetization states (M₁ and M₂) consistent with the Neel-Arrhenius law. This approach contrasts with conventional designs, such as those based on superconducting-normal metal or metal-insulator transitions, which depend on transitions between ordered and disordered states. The SUN bolometer operates in a unique noise-dominated regime at room temperature, termed as Poissonian digital, where its response can be fine-tuned with small magnetic fields, offering a practical and efficient alternative to cryogenic systems.

SUN bolometers generate stochastic events thermally via absorbed infrared light, with the magnetization of the sensing layer flipping between two stable magnetization states. These flips are read out through a fixed reference layer, which allows measurement of the sensing layer's transitions without modifying the energy barrier. Conventional stochastic MTJs achieve faster stochastic rates using either spin-transfer torque currents at high current densities (>1 MA/cm2) or voltage-controlled magnetic-anisotropy (VCMA) driven voltage pulses that transiently modify the magnetic energy barrier [≈1-10 ns pulses, ≈0.3-10 pJ/bit experimentally; idealized simulations down to ≈0.3 fJ/bit, ≈0.38 ns]. Although some VCMA devices report lower energies (≈11-15 fJ/bit), these exhibit long dwell times (≈20 s, the average time spent in one state before switching), which would severely limit the inference speed.

In contrast, SUN bolometers require only a small magnetic bias (≈1 mT) and a constant electrical bias (≈1.9 μW) to set the operating point. Because stochastic events are triggered intrinsically by optical-to-thermal transduction, no per-bit voltage pulses, high-speed drivers, or active resets are needed, reducing timing, routing, and driver overhead for integrated imaging and in-pixel stochastic inference. This intrinsic mechanism enables low-energy, high-speed stochastic switching at the system level, providing an advantage for energy-efficient sensing and in-pixel computation.

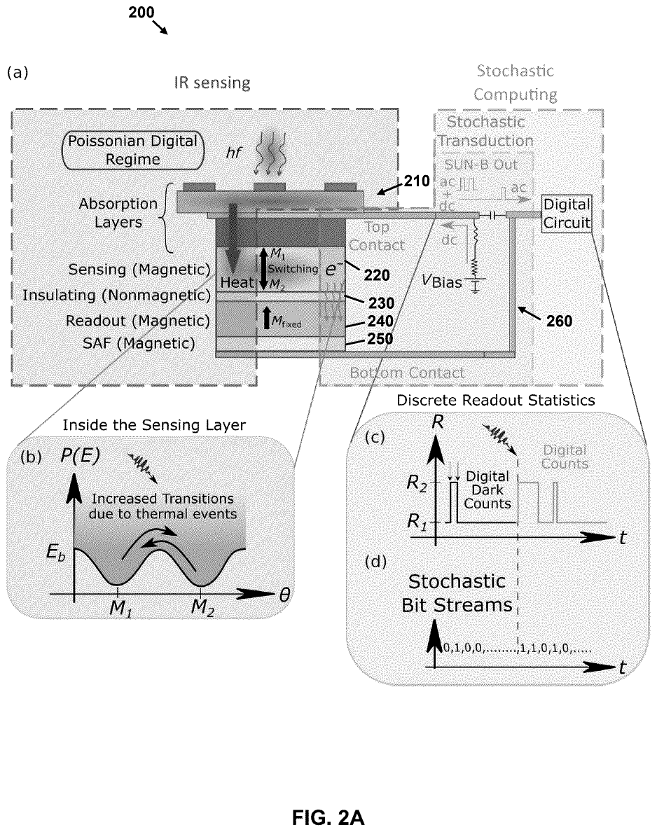

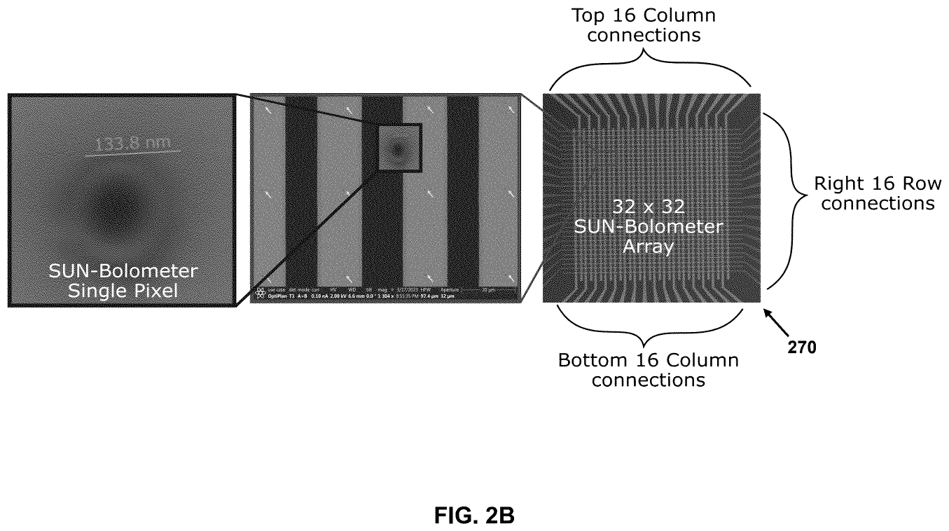

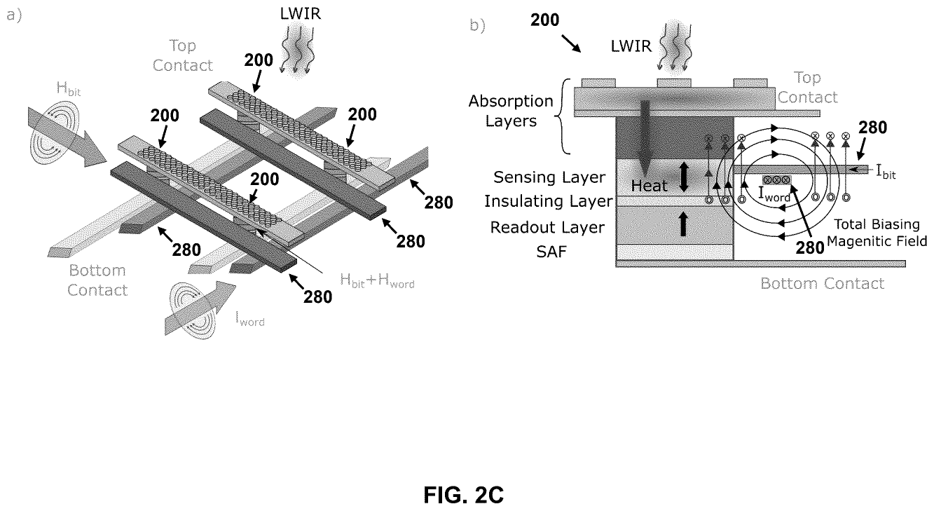

FIG. 2A shows the operation and structure of an exemplary SUN bolometer 200. The device stack of the SUN bolometer 200 includes an absorption stack 210, a magnetic sensing layer 220, a nonmagnetic insulating layer 230, a magnetic readout layer 240, and a synthetic antiferromagnetic (SAF) layer 250. These last four layers form a magnetic tunnel junction (MTJ), which exhibits tunnel magnetoresistance depending on the magnetization orientation of the magnetic sensing layer 220 relative to the magnetic readout layer 240.

The operational mechanism of the SUN bolometer 200 begins with the absorption of incident infrared light by a transduction layer of the absorption stack 210, forming a localized hotspot, and thermalizing heat through the SUN bolometer 200, as shown in illustration (a). This absorption induces thermal energy, which propagates through the SUN bolometer 200, increasing the temperature in the magnetic sensing layer 220. Initially, before this absorption, the magnetic sensing layer 220, composed of spintronic materials, exhibits baseline discrete transitions between two stable magnetization states, M₁ and M₂, driven by natural thermal fluctuations and a small energy barrier. The baseline discrete transitions between stable magnetization states M₁ and M₂ occur due to natural heat and a small energy barrier. However, as the temperature rises due to the hotspot, the probability of transitions between these magnetization states M₁ and M₂ increases, as shown in illustration (b), leading to a higher count rate. This change in transition frequency results in a higher count rate, which is detected as a resistance change in the magnetic readout layer 240, as shown in illustration (c). The SAF layer 250, which is adjacent to the magnetic readout layer 240, stabilizes the readout orientation throughout the process.

The magnetic sensing layer 220 operates in the superparamagnetic regime, where nanoscale dimensions enable thermally activated switching between the two stable magnetization states, M₁ and M₂. Each state is locally ferromagnetically ordered, but thermal fluctuations drive stochastic transitions between orientations, consistent with the field-modified Neel-Arrhenius law:

$${τ}_{{M}_{1}} , {T}_{{M}_{2}} = {τ}_{0} exp ( \frac{MV ( {H}_{K} ∓ H )}{2 {k}_{B} T ) =} ) , \qquad ( 1 )$$

where τ_{M}_{₁}, τ_{M}_{₂} are the mean switching times, τ₀ is the attempt time, M is the magnetization, V is the volume of the magnetic sensing layer 220, H_{K} is the anisotropy field, H is the applied magnetic bias field, k_{B} is Boltzmann's constant, and T is the temperature.

This regime is particularly useful for infrared (IR) detection because incident photons absorbed in the transduction layer locally raise the temperature, thereby reducing the effective energy barrier and accelerating switching. In some embodiments, the magnetic sensing layer 220 is comprised of a CoFeB/CoFe/W multilayer stack, which is engineered to achieve an energy barrier of approximately 161 meV, comparable to mid-long-wave IR photon energies, ensuring strong coupling between IR absorption and stochastic magnetization dynamics.

The SUN bolometer 200 further includes a readout circuit 260 that has a top electrical contact arranged within the absorption stack 210 and a bottom contact at the base of the SUN bolometer 200 connected with the SAF layer 250. The readout circuit 260 applies a DC bias voltage V_{Bias} across the contacts to measure an AC readout signal from the SUN bolometer 200 that corresponds to the resistance changes in the magnetic readout layer 240. A capacitance in the readout circuit 260 removes the DC component to provide the AC readout signal. The AC readout signal is converted into discrete digital pulses and bit streams, as shown in illustration (d). These discrete digital pulses or bit streams represent the detected infrared signal.

The SUN bolometer 200 advantageously achieves high sensitivity and ultrafast readout speeds due to its nanoscale active readout volume, making it capable of detecting high count rates of up to 558 Mcps, surpassing the performance of traditional bolometers and vanadium dioxide detectors. The design of the SUN bolometer 200 achieves a low-noise equivalent temperature difference (high thermal sensitivity) of about 103 mK at 25 Hz and ultrafast readout speeds of about 0.5 GHz (estimated to exceed 2 GHz) due to its nanoscale active readout volume (300×300×2.1 nm³). This nanovolume enables a high readout speed that surpasses the performance of traditional bolometers.

The SUN bolometer 200 advantageously enables room-temperature operation and tunable sensitivity via small magnetic fields, which opens up possibilities for further performance improvements, potentially rivaling state-of-the-art cooled imaging technologies. This advancement signifies a paradigm shift in bolometry, leveraging spintronics to achieve digital operation at room temperature, with applications in infrared sensing, quantum communications, imaging, and metrology.

FIG. 2B shows a successful fabrication of a 32×32 SUN bolometer array 270, with a zoomed-in SEM image highlighting a single pixel, demonstrating the capability to produce such arrays. This design allows the SUN bolometer 200 to achieve high sensitivity and ultrafast response times, significantly advancing infrared detection technology.

### Biasing of the SUN Bolometer Arrays

To enable the second bolometer array 120 and third bolometer array 130 to generate stochastic bit-streams defining the first and second sets of weights w⁽¹⁾ and w⁽²⁾, the second bolometer array 130 and the third bolometer array 140 are subjected to predetermined biasing conditions. These predetermined biasing conditions modulate a stochastic behavior of each bolometer in the second bolometer array 130 and the third bolometer array 140 such that they generate respective AC readout signals that are digitized into respective stochastic bit-streams representing the respective weights in the first and second sets of weights w⁽¹⁾ and w⁽²⁾. The predetermined biasing conditions include one or more of applying a predetermined magnetic field to the second bolometer array 130 and the third bolometer array 140, applying predetermined incident light to the second bolometer array 130 and the third bolometer array 140, applying predetermined currents via the readout circuits 260 of the second bolometer array 130 and the third bolometer array 140, and applying predetermined voltages via the readout circuits 260 of the second bolometer array 130 and the third bolometer array 140.

In at least some embodiments, predetermined magnetic fields are applied to the second bolometer array 130 and the third bolometer array 140 to define the first and second sets of weights w⁽¹⁾ and w⁽²⁾. This magnetic biasing directly influences the probability distributions of the generated digital pulses. This control is governed by the Neel-Arrhenius law, where the applied magnetic bias field H modulates the stochastic switching times τ_{M}_{₁}, τ_{M}_{₂} between magnetization states, according to equation (1).

Thus, the biasing conditions of the SUN bolometers within the bolometer arrays directly influence and control the probability distributions of the digital pulses generated by each of the SUN bolometers. These pulses, forming bit-streams, thus represent floating-point numbers corresponding to the learned values of the respective weights, where the probability of a ‘1’ correlates with the weight's value. In particular, higher probabilities of ‘1’s indicate values closer to 1, while lower probabilities suggest values closer to 0. The synaptic weights, defined by these stochastic switching probabilities, are stable and nonvolatile in their statistical properties over experimental time scales, as the underlying superparamagnetic behavior is governed by the Neel-Arrhenius law.

Historically, field-assisted magnetization switching was central to early magnetic random-access-memory (MRAM) and MTJ-based devices, where orthogonal word and bit lines generated localized magnetic fields (via the Biot-Savart law) to selectively write individual cells. This approach enabled nanosecond-scale switching, though it became impractical for deeply scaled technology nodes (below 90 nm) due to current density limitations in the wires. However, for long-wave infrared imaging applications, where typical pixel sizes lie in the range of 5-15 μm, crossbar-compatible field-assisted schemes remain practical. In the design of the neural bolometer 100, efficient magnetic biasing across the bolometer arrays 120, 130 is realized using such a crossbar configuration: bit lines and word lines provide localized bias control, as in MRAM architectures. Leveraging the device's small field-tuning range (≈1 mT), this method supports parallel and independent operation across the array without introducing routing complexity.

Thus, in some embodiments, magnetic biasing plays the primary role in the stochastic behavior of the second bolometer array 130 and the third bolometer array 140, enabling independent control of each pixel. The SUN bolometer's small field-tuning requirement (on the order of ≈1 mT) allows energy-efficient biasing with minimal overhead, ensuring both precision and scalability in large-format arrays. The neural bolometer 100 enables both in-plane and out-of-plane magnetic configurations, depending on the orientation of the sensing ferromagnetic layer's magnetic moment. In the in-plane configuration, the magnetic moment lies parallel to the plane of the layers, while in the out-of-plane configuration, the moment is oriented perpendicular to the plane. Each geometry requires a specific biasing strategy to achieve uniform and stable operation across the array.

FIG. 2C shows an exemplary magnetic biasing strategy for a SUN bolometer array in an out-of-plane configuration. In this design, the effective magnetic bias is achieved by the superposition of the local magnetic fields generated by word and bit line currents (I_{word} and I_{bit}), which are passed through conductors 280. By controlling these currents independently, we can precisely tune the magnetic biasing of each SUN-bolometer pixel, enabling programmable control of the stochastic switching behavior. Illustration (a) shows a 3D view, where the magnetic moment is oriented perpendicular to the device plane. Illustration (b) shows a 2D view, highlighting a current line that generates the perpendicular bias field. These figures emphasize the design flexibility of the word/bit line approach for scalable SUN-bolometer integration.

The stochastic switching times τ_{M}_{₁} and τ_{M}_{₂} of the two magnetization states under a bias field H and temperature T follow the field-modified Neel-Arrhenius in equation (1). The corresponding state probabilities are given by:

$$P ( {M}_{1} ) = \frac{{τ}_{{M}_{1}}}{{τ}_{{M}_{1}} + {τ}_{{M}_{2}}} , P ( {M}_{2} ) = \frac{{τ}_{{M}_{2}}}{{τ}_{{M}_{1}} + {τ}_{{M}_{2}}} . \qquad ( 2 )$$

By tuning the applied magnetic bias H, the effective energy barriers are shifted, directly modulating τ_{M}_{₁} and τ_{M}_{₂} and hence the state probabilities P(M₁) and P(M₂). Since the statistics of probabilistic bit streams represent synaptic weights, this mechanism enables continuous, bias-controlled adjustment of weights. The resulting switching events remain Poisson-distributed, with the mean rate governed by bias-controlled transition dynamics.

### Neural Network Implementation Using the Neural Bolometer

As mentioned above, the neural bolometer 100 includes one or more digital circuits including, for example, the first digital circuit 150 and the second digital circuit 160, which implement an artificial neural network that performs an image processing task on a thermal image X that is generated by the first bolometer array 120.

To demonstrate the effectiveness of our neural bolometer system for pattern recognition, we use the MNIST dataset as a benchmark for evaluating handwritten digit classification. The MNIST dataset comprises 60,000 training LWIR images and 10,000 test LWIR images, each depicting a 28×28-pixel gray-scale image of a handwritten digit. For our application, these images are down-sampled to 14×14 pixels to optimize processing efficiency, resulting in an input layer size of 196 neurons, implemented using SUN bolometers.

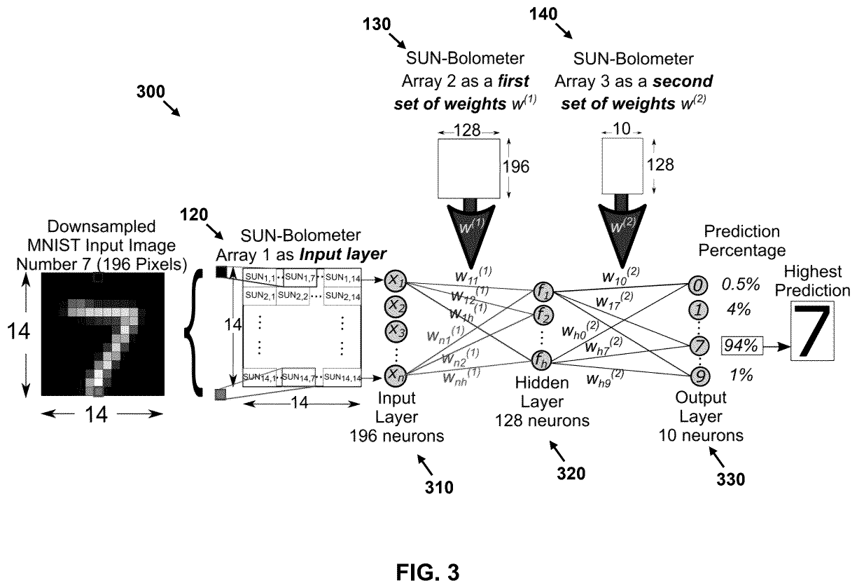

FIG. 3 shows a detailed schematic of the ANN architecture 300 for the neural bolometer 100. The ANN architecture 300 includes an input layer 310 that receives the thermal image X from the first bolometer array 120. In the illustrated embodiment, the first bolometer array 120 comprises a 14×14 array of bolometers, thus, the thermal image X also has dimensions 14×14. The thermal image X is flattened before being provided to the input layer 310. The input layer 310 has 196 neurons xᵢ, which receive the stochastic bit-streams corresponding to each pixel of the thermal image X.

Next, the ANN architecture 300 includes a hidden layer 320 that determines an intermediate output fₕ by performing an operation on the thermal image X using the weights w⁽¹⁾ from the second bolometer array 130. In the illustrated embodiment, the second bolometer array 130 comprises a 128×196 array of bolometers, thus, the first set of weights w⁽¹⁾ also has dimensions 128×196. The hidden layer 320 has 128 neurons fₕ, which determine the intermediate output fₕ.

Finally, ANN architecture 300 includes an output layer 330 that determines a final output y of the image processing task by performing an operation on the intermediate output fₕ using the weights w⁽²⁾ from the third bolometer array 140. In the illustrated embodiment, the third bolometer array 140 comprises a 10×128 array of bolometers, thus, the second set of weights w⁽²⁾ also has dimensions 10×128. The output layer 330 has 10 neurons yⱼ, which determine the final output yⱼ.

In the illustrated example, the hidden layer 320 and the output layer 330 are fully-connected layers. Accordingly, the operation of the j-th neuron in the fully-connected layer k

$$( i . e . , k = 1 , 2 for the hidden and the output layer , respectively ; {y}_{j}^{0} = {x}_{j} )$$

can be defined as follows:

$${y}_{j}^{k} = {f}_{a} ( {\sum }_{i = 0}^{{n}_{k} - 1} {w}_{ij}^{k} {y}_{i}^{k - 1} ) , \qquad ( 3 )$$

where

$${w}_{ij}^{k}$$

is the SUN bolometer bias-controlled synaptic weight (i.e.,

$${w}_{ij}^{1}$$

for the hidden layer and

$${w}_{ij}^{2}$$

for the output layer), nₖ is the number of neurons in layer k, and fₐ(x) is the activation function.

However, it should be appreciated that the neural bolometer 100 can be adapted to perform a wide variety of thermal image processing tasks using a variety of different neural network architectures. Alternative neural network architectures may include, for example, convolutional neural networks, recurrent neural networks, or Transformer neural networks. In such architectures, the neurons thereof will perform different operations compared to the fully-connected layers described herein. Alternative thermal image processing tasks may include classifying the thermal image in various respects (e.g., classifying an object captured in the image) or performing pixel-wise image segmentation.

The first and second sets of weights w⁽¹⁾ and w⁽²⁾ are derived in a training process based on a plurality of training data for a thermal image processing task that is to be learned (e.g., classification of MNIST digits). The learned values for the weights w⁽¹⁾ and w⁽²⁾ are implemented by the second bolometer array 130 and the third bolometer array 140, respectively. In particular, the second bolometer array 130 and the third bolometer array 140 are each subjected to predetermined biasing conditions such that the stochastic bit-streams provided by the bolometers thereof stochastically represent the learned values for the weights w⁽¹⁾ and w⁽²⁾

### Hardware Implementation of the Neural Bolometer

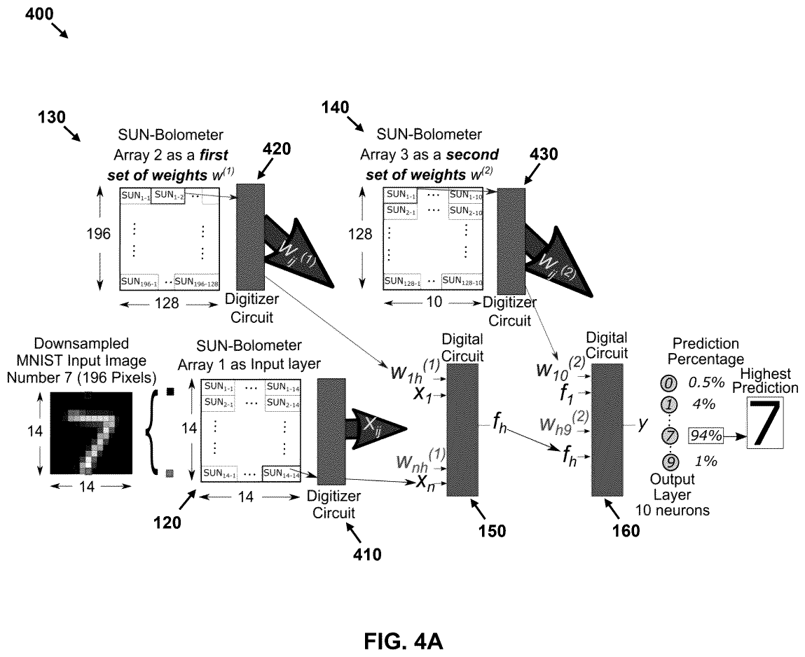

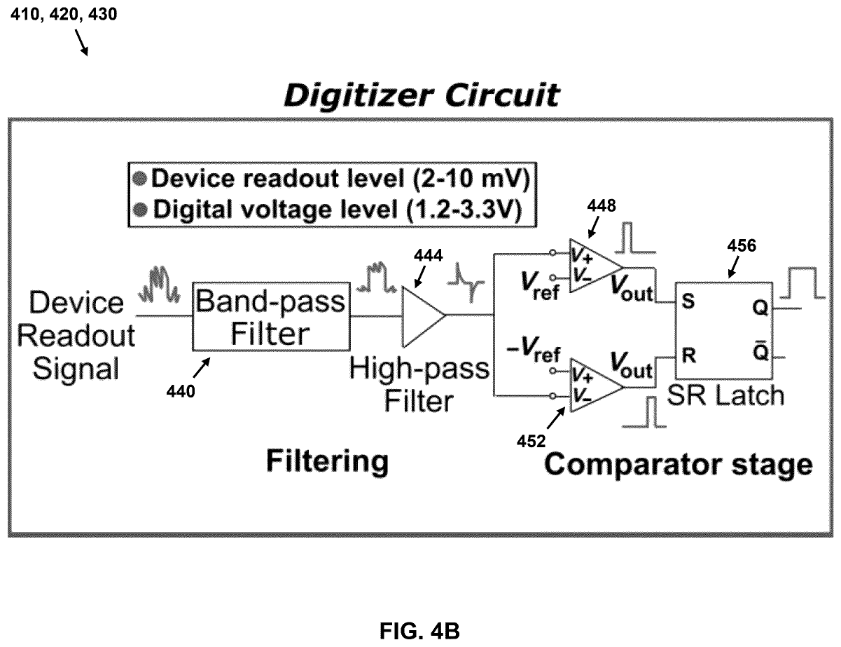

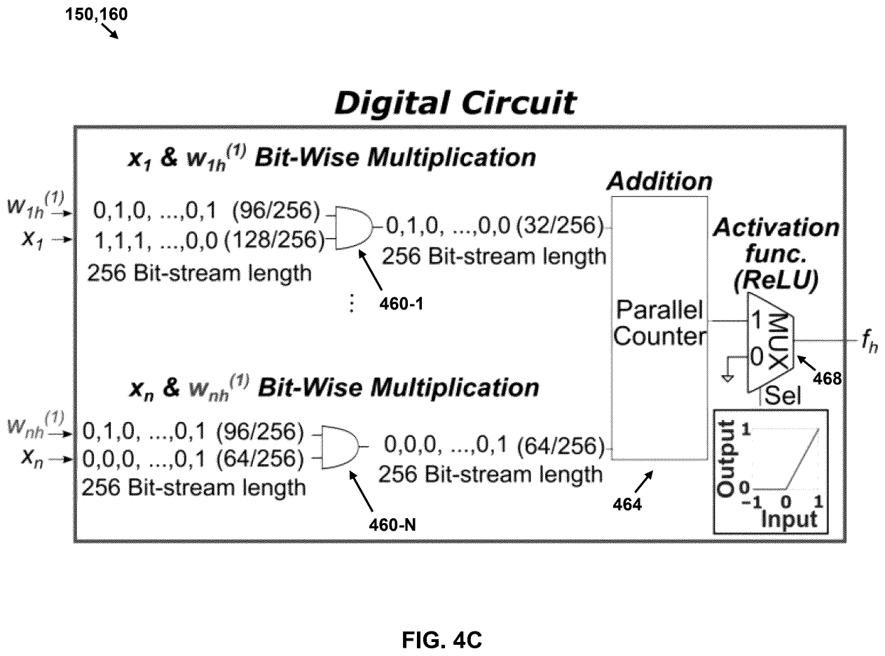

FIG. 4A shows a detailed hardware implementation 400 of the neural bolometer 100, focusing on the computational process used for pattern recognition. As mentioned above, the neural network architecture of the neural bolometer 100 is implemented by one or more digital circuits including, for example, the first digital circuit 150 and the second digital circuit 160. Additionally, the neural bolometer 100 includes a plurality of digitization circuits 410, 420, 430 configured to digitize the stochastic outputs of the bolometer arrays 120, 130, 140 into digital signals suitable for processing by the digital circuits 150, 160 (e.g., 1.2-5V digital signals).

With reference to FIG. 4A, the signal flow from the input thermal image X (e.g., MNIST digit 7) to the prediction output y is illustrated. Initially, the first bolometer array 120 captures the input thermal image X and generates respective stochastic readout signals corresponding to the respective pixels of the input thermal image X. In their analog form, the stochastic readout signals from the bolometer arrays 120, 130, 140 are AC signals having a small voltage amplitude (e.g., about 40 mV). The digitization circuits 410, 420, and 430 convert these analog signals into corresponding digital signals having a voltage suitable for processing by the digital circuits 150, 160 (e.g., 1.2-5V).

A first digitization circuit 410 converts the stochastic readout signals from the first bolometer array 120 into corresponding digital signals having a voltage suitable for processing by the digital circuits 150, 160 (e.g., 1.2-5V). In this way, the digitization circuits 410 generates the input thermal image X in the form of stochastic bit-streams defining values for each pixel in the input thermal image X.

Similarly, the second bolometer array 130 and the third bolometer array 140 generate respective stochastic readout signals corresponding to the respective weights in the first and second sets of weights w⁽¹⁾ and w⁽²⁾. A second digitization circuit 420 and a third digitization circuit 430 convert the stochastic readout signals from the second bolometer array 130 and the third bolometer array 140, respectively, into corresponding digital signals having a voltage suitable for processing by the digital circuits 150, 160 (e.g., 1.2-5V). In this way, the second digitization circuit 420 and the third digitization circuit 430 generate the first and second sets of weights w⁽¹⁾ and w⁽²⁾ each in the form of stochastic bit-streams defining values for each weight in the first and second sets of weights w⁽¹⁾ and w⁽²⁾.

FIG. 4B shows a detailed hardware implementation of the digitization circuits 410, 420, and 430. As can be seen, the digitization circuits 410, 420, and 430 each comprise a filtering stage having a band-pass filter 440, followed by a high-pass filter 444. The filtering stage receives the stochastic readout signals from the corresponding bolometer array 120, 130, 140. The band-pass filter 440 is configured to reduce high-frequency noise and stabilize the signal. Next, the high-pass filter 444 filter is configured to capture the transitions (clicks) in the respective SUN bolometer's output.

The digitization circuits 410, 420, and 430 each further comprise a comparator stage having a first comparator 448, a second comparator 452, and a set-reset (SR) latch 456. The first comparator 448 is configured to compare the filtered signal with a positive reference voltage V_{ref} to detect positive transitions (clicks) in the respective SUN bolometer's output. The second comparator 452 is configured to compare the filtered signal with a negative reference voltage—V_{ref} to detect negative transitions (clicks) in the respective SUN bolometer's output.

The output from the first comparator 448 (representing the positive transitions) is fed to the set input of the SR latch 456 to set the digital output Q of the digitization circuit 410, 420, and 430. The output from the second comparator 452 (representing the negative transitions) is fed to the reset input of the SR latch 456 to reset the digital output Q of the digitization circuit 410, 420, and 430. This process effectively converts the SUN bolometer's analog stochastic readout signal into a floating-point representation, encoded as stochastic bit-streams suitable for digital processing. The resulting digital signals are then suitable for subsequent processing by the digital circuits 150, 160, ensuring accurate and efficient handling of the data generated by the SUN bolometers.

With reference again to FIG. 4A, the first digital circuit 150 receives the digital stochastic bit-streams corresponding to the input thermal image X and to the first set of weights w⁽¹⁾ from the first digitization circuit 410 and the second digitization circuit 420, respectively. As discussed above, the first digital circuit 150 implements the hidden layer 320 and is thus configured to perform matrix multiplication of the received digital stochastic bit-streams, i.e., X·w⁽¹⁾, followed by rectified linear unit (ReLU) activation. Since X has dimensions 196×1 and the first set of weights w⁽¹⁾ have dimensions 128×196, the intermediate output fₕ calculated by the first digital circuit 150 has dimensions 128×1. The first digital circuit 150 provides the intermediate output fₕ in the form of stochastic bit-streams defining values for each element in the intermediate output fₕ.

The second digital circuit 160 receives the digital stochastic bit-streams corresponding to the intermediate output fₕ and to the second set of weights w⁽²⁾ from the first digital circuit 150 and the third digitization circuit 430, respectively. As discussed above, the second digital circuit 160 implements the output layer 330 and is thus configured to perform matrix multiplication of the received digital stochastic bit-streams, i.e., fₕ·w⁽²⁾, followed by ReLU activation. Since the intermediate output fₕ has dimensions 128×1 and the first set of weights w⁽¹⁾ have dimensions 10×128, the final output y calculated by the second digital circuit 160 has dimensions 10×1. The values of the final output y represent respective prediction probabilities across the ten MNIST classes (0-9). The digit with the highest probability is selected as the final output.

FIG. 4C shows a detailed hardware implementation of the digital circuits 150, 160. As can be seen, the digital circuits 150, 160 each comprise a plurality of AND gates 460-1, . . . , 460-N configured to perform the bit-wise multiplications, at least one parallel counter 464 configured to perform the bit-wise additions, and a multiplexer 468 configured to apply an activation function. The gates 460-1, . . . , 460-N, the parallel counter 464, and the multiplexer 468 are collectively configured to implement a respective layer of the ANN architecture 300. Particularly, in the illustrated example, the gates 460-1, . . . , 460-N, the parallel counter 464, and the multiplexer 468 implement fully connected layers with ReLU activation, which perform the operations described in equation (3).

The plurality of AND gates 460-1, . . . , 460-N are configured to perform bit-wise multiplications between respective digital stochastic bit-streams to implement the matrix multiplication operations of the corresponding layer of the ANN architecture 300. In the illustrated examples, in which the digital circuits 150, 160 implement fully connected layers, the plurality of AND gates each perform bit-wise multiplication of a respective value of the input to the layer (e.g., a value from X or fₕ) with a respective weight from the set of weights (e.g., from w⁽¹⁾ or w⁽²⁾), so as to perform the operations described in equation (3). The number of AND gates required depends on the size of the input and the set of weights.

It should be appreciated that this bit-wise multiplication of the digital stochastic bit-streams is an approximation of a multiplication of the numbers represented by the probability of ‘1’s in the digital stochastic bit-streams, and is subject to calculation errors. In the illustrated example, the AND gate 460-1 receives sequences of 256 bits from the stochastic bit-streams representing the

$${w}_{1 h}^{( 1 )}$$

and xᵢ. The sequence of 256 bits from the stochastic bit-streams representing

$${w}_{1 h}^{( 1 )}$$

has 96/256 ‘1’s, which represents the floating-point value 0.375. Similarly, the sequence of 256 bits from the stochastic bit-streams representing xᵢ has 128/256 ‘1’s, which represents the floating-point value 0.5. However, the result of the bit-wise multiplication is a sequence of 256 bits having 32/256 ‘1’s, which represents the floating-point value 0.125, which differs from the correct result of the multiplication, 0.1875. However, over time, the average result of the bit-wise multiplication will gradually approach the correct result of the multiplication, 0.1875.

With continued reference to FIG. 4C, the at least one parallel counter 464 is configured to perform bit-wise addition between the outputs of the plurality of AND gates 460-1, . . . , 460-N. In the illustrated examples, in which the digital circuits 150, 160 implement fully connected layers, the parallel counter is configured to add the bit-wise multiplication results from particular subsets of the plurality of AND gates 460-1, . . . , 460-N, so as to perform the operations described in equation (3). For each respective neuron j in the layer, the at least one parallel counter 464 adds the multiplication results of the input to the layer (e.g., each value from X or fₕ) multiplied by weights from a corresponding column j the set of weights (e.g., from w⁽¹⁾ or w⁽²⁾), to yield a summation result j. It should be appreciated that, in alternative embodiments, a multiplexer can be used to determine the summations by accumulation, rather than using the at least one parallel counter 464.

Finally, the multiplexer 468 is configured to apply ReLU activation to introduce non-linearity and determine the output of the layer. The selection line of the multiplexer 468 is used as the sign bit. Thus, the multiplexer 468 ties a ‘0’ input to the ground and a ‘1’ input to the bit-stream signal.

With reference again to FIG. 4A, this efficient processing framework leverages the stochastic nature of the SUN bolometers to enhance the classification accuracy of the MNIST dataset while ensuring high-speed performance. The design and hardware implementation of the neural bolometer 100 are optimized to effectively handle the computational demands of real-time pattern recognition tasks, making it suitable for diverse applications beyond handwritten digit classification.

### Experiment-Driven Simulation Results

Transitioning from the design of the neural bolometer 100 to its practical performance, our experiment-driven simulations reveal its efficiency, achieving a classification inference time of approximately 2.6 μs. This performance notably surpasses traditional optical neural networks, which require around 4.3 μs. The system's compact and energy-efficient design makes it particularly suitable for edge computing applications, including augmented reality, autonomous navigation, IoT, and health wearables. By integrating the first bolometer array 120 as the sensory input layer, with the second bolometer array 130 and the third bolometer array 140 dedicated to neuromorphic computing, the neural bolometer 100 not only achieves accurate classification but also offers significant potential for advanced edge detection and pattern recognition in real-time thermal imaging applications.

In our experiment, we evaluated the sensitivity of the SUN bolometer under various magnetic field biases. The bolometer was tested across magnetic fields of 105-185 Oe. We observed a significant increase in counts when the laser was ‘ON’, demonstrating that the magnetic field effectively modulates the device's sensitivity to light.

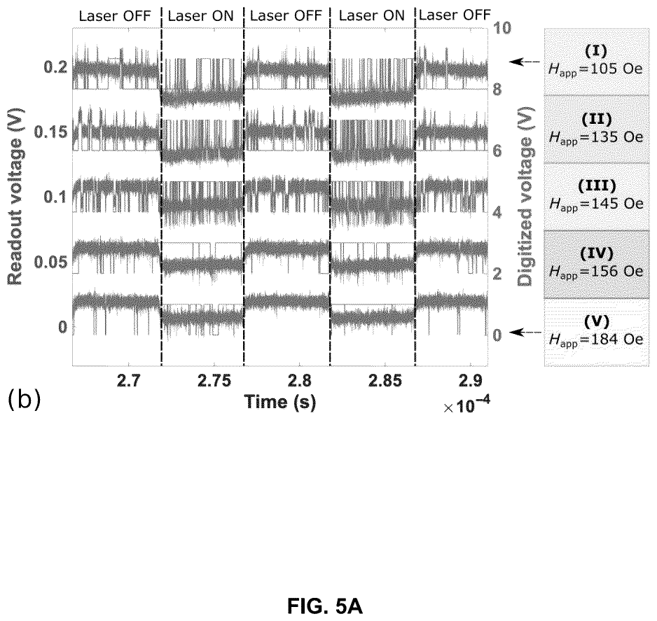

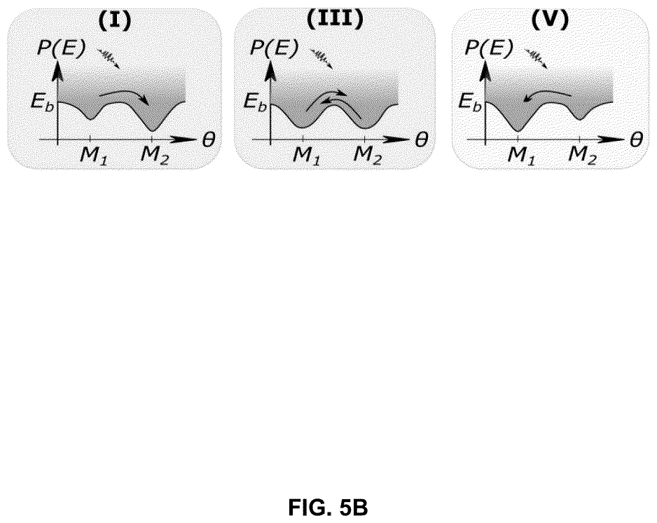

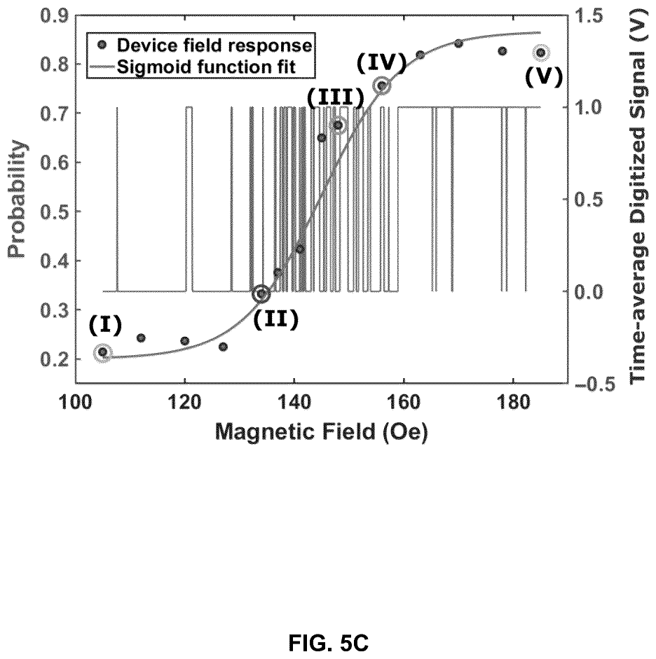

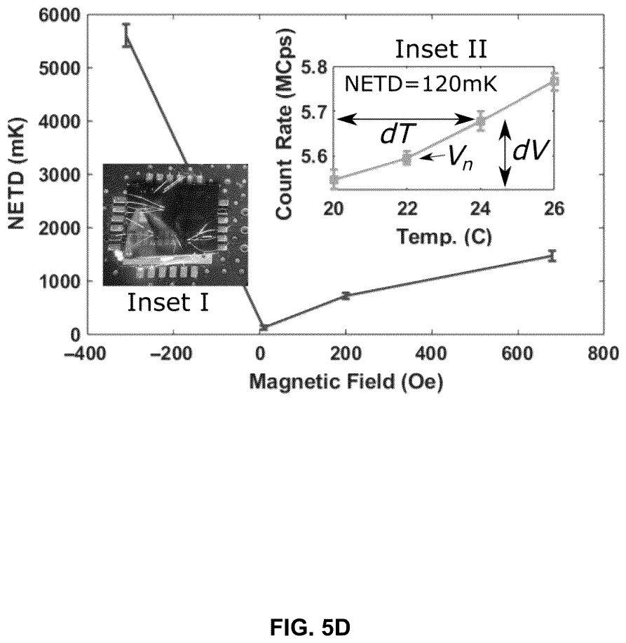

FIG. 5A shows the experimental output of a single-pixel SUN bolometer (blue) compared with the simulated digital output (red) from the digitization circuit under varying magnetic field conditions, showcasing controlled probability modulation. Note: SUN bolometer signals at different magnetic field values are artificially offset for clarity. The graph shows the device's voltage waveforms (blue) in both the ‘ON’ and ‘OFF’ states for these magnetic fields. The results show that the sensitivity, indicated by the number of counts, can be precisely tuned by adjusting the magnetic field.

FIG. 5B shows a corresponding energy diagram of the two magnetic states under field bias. As the applied magnetic field deviates from the stray-field-induced offset of 148 Oe, the energy barrier between magnetization states increases, thereby reducing the device's sensitivity. This finding confirms that higher magnetic fields reduce thermally activated transitions and aligns with our theoretical expectations.

FIG. 5C shows experimentally measured SUN-bolometer click rates under different bias fields, which were digitized and fitted to a stochastic sigmoid function. A noise parameter was included in the simulation to reflect the observed variability, ensuring the fitted function remains anchored to experimental data rather than being purely theoretical. The precise modulation of the magnetic field directly controls both the stochasticity and sensitivity of the device, enabling a dual advantage in edge applications. This unique capability of our neural bolometer enhances both sensing and computing, making it well-suited for real-time processing.

FIG. 5D shows noise equivalent differential temperature (NEDT) versus the applied magnetic field. Inset I shows an optical image of the SUN-B sample. Inset II shows a response of the SUN bolometer to LWIR thermal radiation, with NETD calculated from the variation in counts and scene temperature (dV and dT) and the standard deviation of 30 measurements (detector noise; Vn). Integration time: tᵢₙₜ=24 ms.

We demonstrate the SUN bolometer's response to thermal radiation in the long-wave infrared spectrum, focusing on its noise-equivalent temperature difference (NETD) under varying magnetic fields, as shown in FIG. 5D. Device II incorporates a plasmonic nanoantenna array designed to significantly enhance LWIR absorption efficiency and sensitivity compared to the baseline device I. The experiment involved exposing the device to thermal light from an extended-area blackbody source, which was focused onto the bolometer using an LWIR ZnSe lens with an f/0.5 aperture. The response of the SUN bolometer (device II) to this thermal light at 0 Oe is plotted in inset II of FIG. 5D, where we used the resulting data to calculate the NETD, a critical measure of thermal sensitivity. The NETD is defined as

$$NETD = \frac{{V}_{n}}{dV / dT} , \qquad ( 4 )$$

where Vₙ represents the noise (i.e., the standard deviation of 30 measurements of the detector signal) at a black body temperature of 298K, and dV/dT is the change in detector signal per degree of temperature change. With an integration time of 24 ms, corresponding to a pixel readout frequency of 41.7 Hz, NETD is measured to be 120 mK, indicating its suitability for high-quality infrared imaging applications.

Building on the measurements presented in FIG. 5A, we emphasize the SUN bolometer's highly tunable sensitivity achieved through magnetic field adjustments. This tunability in NETD allows the sensors to deliver optimal performance across varying environmental conditions, minimize energy consumption, reduce background noise, and adapt seamlessly to application-specific requirements.

To validate our design, we performed simulations using a multilayer perceptron (MLP) network to train our artificial neural network model, focusing on optimizing the biasing values. During the training phase, we achieved a classification accuracy of 96.6% (which can be enhanced by increasing the bit-stream length) on the LWIR MNIST training dataset after 30 epochs. Training was conducted using backpropagation and stochastic gradient descent, aiming to minimize cross-entropy loss. The optimized synaptic weights and biases obtained from this training were then implemented in our SUN-bolometer-based ANN, forming the artificial neural computation model.

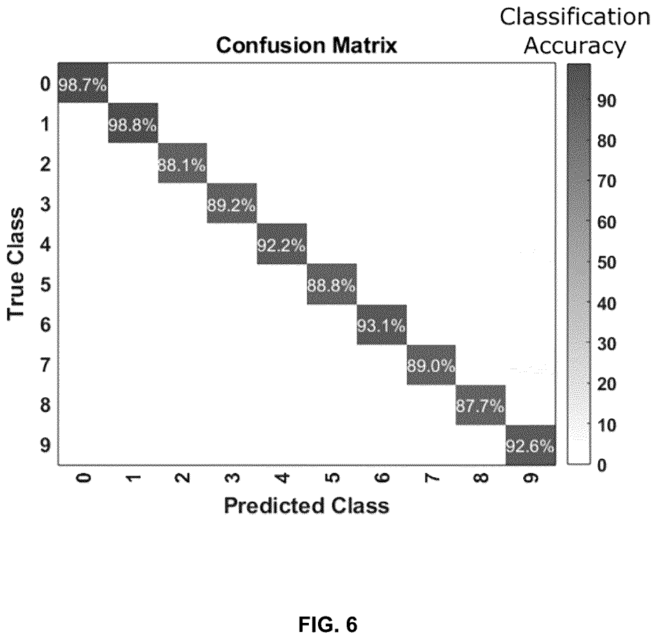

FIG. 6 shows a confusion matrix showing the MNIST classification results from the neural bolometer 100 (Predicted class) versus the ground truth (True class). Using 256-bit-long stochastic bit streams, the classification accuracy for the 10 LWIR MNIST classes is summarized in the confusion matrix shown in FIG. 6. The classification accuracy is defined as

$$classification accuracy = \frac{no . of correct predictions}{total no . of input samples} , \qquad ( 5 )$$

The confusion matrix normalizes the number of correct and incorrect classifications for each digit class, demonstrating the effective handwritten digit classification capability of our model. The ANN computation model achieved a classification accuracy of 92.5% on the LWIR MNIST test set.

### Performance Comparison of Advanced Neural Computing Technologies

There are no neural bolometers in the infrared regime. Therefore, we compare our LWIR neural bolometer performance to other recent visible neural computing technologies, as shown in Table I.

TABLE 1

| | MNIST | | | | Energy | | No of | Inference | |
|---|---|---|---|---|---|---|---|---|---|
| Method | Accuracy | TOPs | TOPs/W | FPS | per bit | | bits | time | |
| Neural Bolometer | 92.5% | 0.2 | 4.2 | 390625 | 60.8 | fJ | 8 | 2.82 | μs |
| MRAM-based | 95% | 0.78 | — | 0.008 | — | | 2 × 10 | 2 | min |
| ONN | 88% | 0.48 | 1.26 | 233,645 | 98.8 | fJ | 8 | 4.28 | μs |
| Jetson Nano | 98.7% | 0.47 | 0.076 | 118.5 | 9.5 | mJ | 8 | 8.44 | ms |
| SCAMP-5 | 96.9% | — | — | 2200 | 0.7 | mJ | Analog | 542 | μs |

Inference time is the duration a model takes to process an input and generate an output. In our approach, each LWIR MNIST pixel is represented as a 256-bit stream, and all pixels are processed in parallel. The inference time is therefore determined by the time required to process a single pixel. The latency per bit corresponds to the time taken to propagate through the processing pipeline, including the response time for input layer (1-ns latency≡1-GHz readout speed), the first synaptic weight set w1 (1-ns latency), and digital circuit operations (4 ns), followed similarly by the second synaptic weight set w2 and the digital circuit operations (1 ns+4 ns), totaling 11 ns:

t_{Total Inference}=1 ns+(1 ns+4 ns)×2=11 ns. (6)

Thus, the total inference time is

t_{Total Inference}=11 ns×256-bit stream=2.82 μs (7)

Notably, our approach achieves a shorter inference time than optical neural networks (ONNs) (4.3 μs), due to the reduced bit-stream count and the fast response of our device. ONNs, which are based on convolutional neural network architectures, are designed for diverse classification tasks but are less optimized for LWIR MNIST. In contrast, our method leverages a compact MLP network, providing a more efficient solution for this dataset.

Each device operates at a power consumption of 1.9 μW, and input data are represented as 256-bit streams encoding floating-point values with an 8-bit resolution. The energy consumed per bit per device is computed by dividing the device power consumption (1.9 μW) by the device bit rate, which is defined as the resolution (8 bits) per device inference time (1 ns×256):

$$energy / bit = 1.9 μW / ( \frac{8}{1 ns \times 256} ) = 60.8 fJ / bit \qquad ( 8 )$$

The operations per second (OPS) are calculated based on the number of computations required to process the data. Each computational operation typically consists of multiple suboperations, such as multiplication and addition. Therefore, the total number of operations is considered to be twice the number of higher-level computations. The maximum number of operations that can be performed simultaneously is 196×128, corresponding to the number of pixels processed at once. The OPS are given by the following equation:

$$OPS = \frac{2 \times 1 GHz \times ( 196 \times 128 pixels )}{256} = 0.2 TOPs \qquad ( 9 )$$

Finally, the efficiency, measured in operations per watt (OPS/W), is defined as the ratio of operations per second (OPS) to the power consumption required to perform those operations, ignoring the power consumed by the digital circuit, as it is negligible:

$$OPS / W = \frac{0.2 TOPs}{1.9 μW \times ( 196 \times 128 pixels )} = 4.2 TOPS / W \qquad ( 10 )$$

Compute density is the computational speed (OPS) divided by the area: device area is 300 nm×300 nm×25 kilopixel=2.25×10-3 mm², and area of digital circuits is ≈0.25×10-3 mm2), so total estimated area is 2.5×10-3 mm2. Thus

$$OPS / {mm}^{2} = \frac{0.2 TOPs}{2.5 \times 1 {0}^{- 3} {mm}^{2}} = 80 TOPS / {mm}^{2} \qquad ( 11 )$$

These calculations highlight the efficiency of the neural bolometer 100, setting the stage for comparison with recent advancements in neural computing that aim to optimize artificial neural networks further for LWIR MNIST classification.

Recent advancements in neural computing, such as MRAM-based stochastic computing, utilize magnetic tunnel junctions as random-number generators for enhanced energy and area efficiency. These systems rely on reading out the same device multiple times in a sequential readout technique, resulting in a longer inference time (2 min) using 1024-bit streams while achieving high LWIR MNIST classification accuracy of 95%. In contrast, the neural bolometer 100 achieves fast stochastic computing by utilizing magnetic, voltage, temperature, and optical biasing for enhanced stochastic probability control. Our implementation utilizes a simpler activation-function implementation for ReLU using a MUX, partly parallel readout, and a reduced bitstream length (256). Our system achieves 92.5% LWIR MNIST accuracy, 434 783 frames per second (FPS), and an inference time of just 2.82 μs, significantly outperforming MRAM-based designs in both speed and efficiency. Comparatively, ONNs, ANN implementations on Jetson Nano, and analog focal-plane processors like SCAMP-5 exhibit unique strengths but fall short in latency, energy efficiency, or application scope, emphasizing the versatility and high-speed performance of the neural bolometer 100 for edge applications.

While the disclosure has been illustrated and described in detail in the drawings and foregoing description, the same should be considered illustrative and not restrictive in character. It is understood that only the preferred embodiments have been presented and that all changes, modifications, and further applications that come within the spirit of the disclosure are desired to be protected.

What is claimed is:

1. A thermal imaging system comprising:
a first array of bolometers configured to generate a thermal image;
at least one further array of bolometers configured to generate at least one set of weights; and
at least one digital circuit configured to implement an artificial neural network that performs an image processing task, the artificial neural network having (i) an input layer that receives the thermal image from the first array of bolometers and (ii) at least one additional layer that generates an output of the image processing task by performing at least one operation on the thermal image using the at least one set of weights.

2. The thermal imaging system of claim 1, the at least one further array of bolometers comprising:
a second array of bolometers configured to generate a first set of weights; and
a third array of bolometers configured to generate a second set of weights.

3. The thermal imaging system of claim 2, wherein the at least one additional layer of the artificial neural network includes:
a hidden layer that generates an intermediate output by performing a first operation on the thermal image using the first set of weights from the second array of bolometers; and
an output layer that generates an output of the image processing task by performing a second operation on the intermediate output from the hidden layer using the second set of weights from the third array of bolometers.

4. The thermal imaging system of claim 3, wherein at least one of the hidden layer and the output layer is a fully connected layer.

5. The thermal imaging system of claim 3, the at least one digital circuit comprising:
a first digital circuit operably connected to receive the thermal image and the first set of weights and configured to implement the hidden layer by performing the first operation; and
a second digital circuit operably connected to receive the intermediate output and the second set of weights and configured to implement the output layer by performing the second operation.

6. The thermal imaging system of claim 1 further comprising:
a first digitization circuit configured to (i) receive first readout signals from the first array of bolometers and (ii) generate thermal image by digitizing the first readout signals; and
at least one second digitization circuit configured to (i) receive second readout signals from the at least one further array of bolometers and (ii) generate the at least one set of weights by digitizing the second readout signals.

7. The thermal imaging system of claim 6, wherein each of the first digitization circuit and the at least one second digitization circuit comprises:
at least one filter configured to generated a filtered readout signal that represents positive transitions and negative transitions in the first readout signals or second readout signals; and
a comparator circuit configured to digitize the first readout signals or second readout signals based on the positive transitions and the negative transitions.

8. The thermal imaging system of claim 7, wherein the comparator circuit comprises:
a first comparator configured to capture the positive transitions by comparing the filtered readout signal with a positive reference voltage;
a second comparator configured to capture the negative transitions by comparing the filtered readout signal with a negative reference voltage; and
a set-reset latch connected to the first comparator and the second comparator such that an output of the set-reset latch is set based on an output of the first comparator and reset based on an output of the second comparator.

9. The thermal imaging system of claim 6, wherein:
the first digitization circuit is configured to generate the thermal image as a first plurality of stochastic bit-streams, each stochastic bit-stream in first plurality of stochastic bit-streams representing a respective pixel in the thermal image; and
the at least one second digitization circuit is configured to generate the at least one set of weights as at least one second plurality of stochastic bit-streams, each stochastic bit-stream in the at least one second plurality of stochastic bit-streams representing a respective weight in the at least one set of weights.

10. The thermal imaging system of claim 9, wherein the at least one digital circuit is configured to implement the artificial neural network by performing bit-wise multiplications and bit-wise additions of respective bit-streams from the first plurality of stochastic bit-streams and the at least one second plurality of stochastic bit-streams.

11. The thermal imaging system of claim 10, wherein the at least one digital circuit includes a plurality of AND gates configured to perform the bit-wise multiplications.

12. The thermal imaging system of claim 10, wherein the at least one digital circuit includes at least one parallel counter configured to perform the bit-wise additions.

13. The thermal imaging system of claim 12, wherein the at least one parallel counter is configured to add results from particular subsets of the bit-wise multiplications.

14. The thermal imaging system of claim 10, wherein the at least one digital circuit includes a multiplexer configured to apply an activation function after the bit-wise multiplications and bit-wise additions are performed.

15. The thermal imaging system of claim 9, wherein the at least one further array of bolometers is shielded from thermal radiation from an external environment and subjected to predetermined biasing conditions.

16. The thermal imaging system of claim 15, wherein the predetermined biasing conditions modulate a stochastic behavior of each bolometer in the at least one further array of bolometers such that the at least one further array of bolometers generate the second readout signals that are digitized to into the at least one second plurality of stochastic bit-streams representing the at least one set of weights.

17. The thermal imaging system of claim 15, wherein the predetermined biasing conditions include at least one of (i) a predetermined magnetic field applied to the at least one further array of bolometers, (ii) predetermined incident light applied to the at least one further array of bolometers, (iii) predetermined currents applied to the at least one further array of bolometers, and (iv) predetermined voltages applied to the at least one further array of bolometers.

18. The thermal imaging system of claim 1, wherein each bolometer in the first array of bolometers and in the at least one further array of bolometers comprises:
a transduction layer configured to absorb incident infrared light; and
a magnetic sensing layer composed of spintronic materials, the magnetic sensing layer having a magnetization that transitions between two stable magnetization states with a probability that increases with temperature.

19. The thermal imaging system of claim 18, wherein each bolometer in the first array of bolometers and in the at least one further array of bolometers comprises:
a magnetic readout layer having a resistance that changes depending on the magnetization of the magnetic sensing layer; and
a readout circuit configured to measure changes in the resistance of the magnetic readout layer.

20. The thermal imaging system of claim 1, wherein the output of the image processing task is one of (i) a classification of the thermal image and (ii) a pixel-wise segmentation of the thermal image.
